(19) United States
(12) Patent Application Publication
(10) Pub. No.: US 2013/0021308 A1
(43) Pub. Date: Jan. 24, 2013

(54) ELECTRONIC DEVICE AND METHOD FOR ADJUSTING BACKLIGHT BRIGHTNESS

(71) Applicant: CHI-SHENG GE, Tu-Cheng (TW)

(72) Inventor: CHI-SHENG GE, Tu-Cheng (TW)

(73) Assignee: HON HAI PRECISION INDUSTRY CO., LTD., Tu-Cheng (TW)

(21) Appl. No.: 13/235,445

(22) Filed: Sep. 18, 2011

(30) Foreign Application Priority Data
Jul. 20, 2011 (TW) 100125709

(51) Int. Cl. G09G 3/36; G06F 3/038

(52) U.S. Cl. 345/207; 345/102

(57) ABSTRACT

A device and a method for adjusting backlight brightness employed in a display are provided. The electronic device includes a display unit, a backlight unit, a light sensor, a distance sensor, and a control unit. The backlight unit is configured to emit backlight for the display unit. The light sensor is configured to sense ambient brightness of the electronic device in real time. The distance sensor is configured to sense an object within a predetermined coverage area in real time. The control unit is configured to detect whether the ambient brightness changes, evaluate whether the object is sensed by the distance sensor within the predetermined coverage area when detecting that the ambient brightness is low, and not control the backlight unit to adjust the backlight brightness of the display unit when the object is sensed within the predetermined coverage area.

### BACKGROUND

1. Technical Field

The disclosure relates to electronic devices and, more particularly, to an electronic device and a method for adjusting backlight brightness adapted for the electronic device.

2. Description of Related Art

Conventionally, backlight brightness of an LCD panel applied in a variety of electronic devices, such as mobile phones, digital cameras, and other devices, is adjusted by detecting ambient brightness with an external detector, thereby balancing the ambient luminosity and the backlight brightness. However, when the device is sheltered from an object, such as fingers, face of a user, or other objects, the ambient luminosity of the device becomes low and the backlight brightness will be controlled to become low. Very often, the device cannot correctly determine when to decrease the backlight brightness due to the unintentional coverage of objects around the device.

Therefore, what is needed is an electronic device to overcome the described shortcoming.

### BRIEF DESCRIPTION OF THE DRAWINGS

FIG. 1 is a block diagram of an electronic device, in accordance with an exemplary embodiment.

FIG. 2 is a flowchart of a method for adjusting backlight brightness employed by the electronic device of FIG. 1.

### DETAILED DESCRIPTION

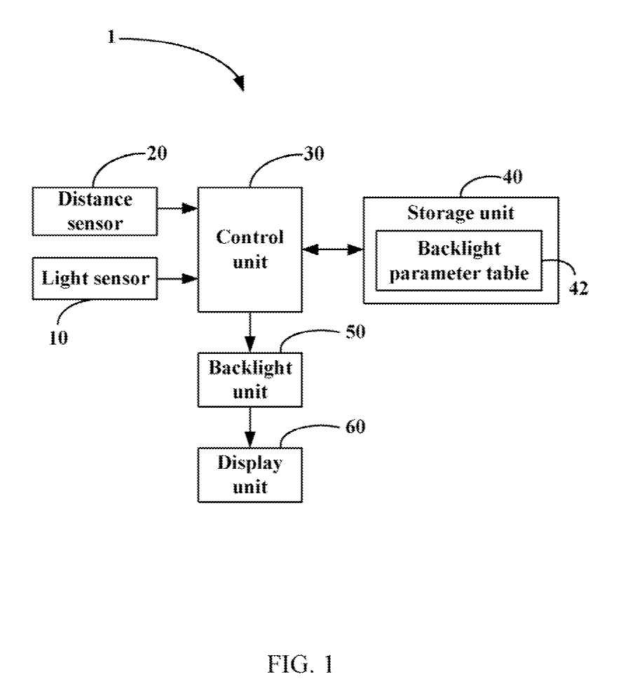

FIG. 1 is a block diagram of an electronic device, in accordance with an exemplary embodiment. The electronic device 1 includes a light sensor 10, a distance sensor 20, a control unit 30, a storage unit 40, a backlight unit 50, and a display unit 60. The backlight unit 50 is configured to emit backlight for the display unit 60. The display unit 60 is an LCD module. The light sensor 10 is configured to sense ambient brightness of the electronic device 1 in real time. The distance sensor 20 is configured to sense an object within a predetermined coverage area in real time.

The storage unit 40 is configured to store a backlight parameter table 42. The table 42 stores relationships between ambient brightness values and backlight parameters. For example, a value of a sensed ambient brightness is 5 lux, the backlight parameter corresponding to the ambient brightness value is 50% in the table 42, that is, decreasing the backlight brightness of the display unit 60 by 50%; the value of another sensed ambient brightness is 10 lux, the backlight parameter corresponding to the ambient brightness value is 30% in the table 42, that is, decreasing the backlight brightness of the display unit 60 by 30%.

The control unit 30 is configured to determine whether the ambient brightness changes. When the control unit 30 detects that the ambient brightness is low, the control unit 30 evaluates whether the object is sensed by the distance sensor 20 within the predetermined coverage area. When the object is sensed within the predetermined coverage area, that is, the object is an obstacle leading that the ambient brightness becomes low, the control unit 30 does not to control the backlight unit 50 to adjust the backlight brightness of the display unit 60. Thus, the backlight brightness of the display unit 60 is not changed.

When the control unit 30 detects that the ambient brightness is low and the object is not sensed within the predetermined coverage area, the control unit 30 is configured to acquire a backlight parameter corresponding to the value of a sensed ambient brightness from the storage unit 40 and control the backlight unit 50 to decrease the backlight brightness of the display unit 60.

Therefore, when detecting that the ambient brightness is low, the electronic device 1 evaluates whether the object is the resulting factor in the change of the ambient brightness. If yes, the electronic device 1 does not adjust the backlight brightness of the display unit 60, and if no, the electronic device 1 decreases the backlight brightness of the display unit 60, thereby bringing an accurate adjustment.

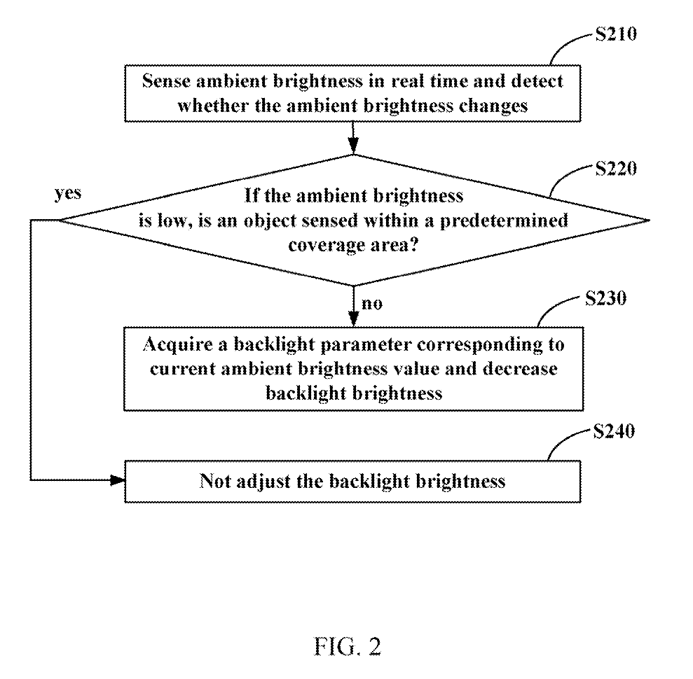

FIG. 2 is a flowchart of a method for adjusting backlight brightness employed by the electronic device of FIG. 1. In step S210, the light sensor 10 senses the ambient brightness of the electronic device 1 in real time and the control unit 30 determines whether the ambient brightness changes. In step S220, when detecting that the ambient brightness is low, the control unit 30 evaluates whether the object is sensed by the distance sensor 20 within the predetermined coverage area. If the object is not sensed within the predetermined coverage area, in step S230, the control unit 30 acquires the backlight parameter corresponding to a sensed ambient brightness value in the table 42 and controls the backlight unit 50 to decrease the backlight brightness of the display unit 60. If the object is sensed within the predetermined coverage area, in step S240, the control unit 30 does not control the backlight unit 50 to adjust the backlight brightness of the display unit 60.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a display unit;
a backlight unit to emit backlight for the display unit;
a light sensor to sense ambient brightness of the electronic device in real time;
a distance sensor to sense an object within a predetermined coverage area in real time; and
a control unit to detect whether the ambient brightness changes, evaluate whether the object is sensed by the distance sensor within the predetermined coverage area when detecting that the ambient brightness is low, and not control the backlight unit to adjust backlight brightness of the display unit when the object is sensed within the predetermined coverage area.

2. The electronic device as recited in claim 1, further comprising a storage unit to store relationships between ambient brightness values and backlight parameters, wherein the control unit is further configured to acquire a backlight parameter corresponding to a value of a sensed ambient brightness from the storage unit and control the backlight unit to decrease the backlight brightness of the display unit when detecting that the ambient brightness is low and the object is not sensed within the predetermined coverage area.

3. A method for adjusting backlight brightness for an electronic device comprising:
sensing ambient brightness of the electronic device in real time and detecting whether the ambient brightness changes;
if the ambient brightness is detected low, evaluating whether an object is sensed within a predetermined coverage area; and
if an object is sensed within the predetermined coverage area, not adjusting backlight brightness of the electronic device.

4. The method for adjusting backlight brightness as recited in claim 3, wherein the electronic device stores relationships between ambient brightness values and backlight parameters, the method further comprising: acquiring a backlight parameter corresponding to a value of a sensed ambient brightness and decreasing the backlight brightness of the electronic device when detecting that the ambient brightness is low and the object is not sensed within the predetermined coverage area.
